(19) United States
(12) Patent Application Publication
(10) Pub. No.: US 2026/0169547 A1
(43) Pub. Date: Jun. 18, 2026

(54) HINT-BASED POWER CONSUMPTION STATE MANAGEMENT OF A COMMUNICATION INTERFACE

(71) Applicant: NVIDIA Corporation, Santa Clara, CA (US)

(72) Inventors: Bhargava Gopireddy, Seattle, WA (US); Sachin Idgunji, San Jose, CA (US)

(21) Appl. No.: 18/978,352

(22) Filed: Dec. 12, 2024

(51) Int. Cl. G06F 1/3296

(52) U.S. Cl. CPC G06F 1/3296

(57) ABSTRACT

Devices, systems, and techniques for managing transitions of power states of a communication interface of a computing node. The techniques include generating an instruction associated with transitioning the communication interface from a first power state to a second power state, where the communication interface communicatively couples a first processing unit and a second processing unit. The techniques further include inserting the instruction into a code set executable by the first processing unit, where the first processing unit executes the instruction to cause the communication interface to transition from the first power state to the second power state.

### TECHNICAL FIELD

At least one embodiment pertains to power management in a computing system. For example, at least one embodiment pertains to managing transition of power consumption states of a communication interface associated with processing units in a computing system deploying machine learning models.

### BACKGROUND

Many computing systems include an array of multiple processing units (e.g., central processing units (CPUs), graphics processing units (GPUs)) that communicate with one another via high-speed communication interfaces. As such systems scale and the number of processing units and system bandwidth increases, the number of communication interfaces required to manage the processing unit-to-processing unit communication increases. The power consumption associated with this increased number of communication interfaces has also increased and can represent a significant fraction of a total power consumed by the system.

One approach to reducing the power consumed by a communication interface is to place or transition the communication interface into a low power state (e.g., a power savings state, herein referred to as “L1” or a “L1 power state”), when the communication interface is not being used (i.e., the communication interface is in an inactive stage). A communication interface is dynamically transitioned from the L1 power state by an L1 exit operation, which incurs an exit latency (herein the “L1 exit latency”).

A key challenge in dynamically entering and exiting the L1 power state is to ensure that the latency of L1 exit operation does not negatively affect the performance of the application under consideration. Reducing the power consumption using the L1 power state transitioning requires precise timing and synchronization of the transition from the L1 power state to the active power state of the communication link (i.e., waking up the communication interface) with operations of one or more communication kernels. In certain approaches, threshold criteria is established to determine when the communication interface is transitioned from the active power state to the L1 power state (i.e., the L1 entry threshold). Typically, the L1 entry threshold is set conservatively to ensure the communication interface remains in the active power state and “ready” to execute any performance critical applications.

However, this results in the communication interface remaining in the active power state at times when the communication interface is not in use. Inefficient management of the transitioning of the communication interface between the active power state and the L1 power state results in an undesired increase in consumption of power by the communication interface.

### BRIEF DESCRIPTION OF DRAWINGS

FIG. 1 is a block diagram of an example computing system including a hint manager configured to manage transitions of power states associated with one or more communication interfaces of one or more computing nodes, in accordance with at least some embodiments;

FIG. 2 illustrates an example hint manager configured to identify communication instances associated with an AI model, according to at least one embodiment;

FIG. 3 illustrates an example compile time stage of a computing system during which a hint manager identifies one or more communication instances associated with execution of an artificial intelligence model including a neural network graph, according to at least one embodiment;

FIG. 4 illustrates an example flow relating to a hint manager generating a hint instruction relating to transitioning of a communication interface from a first power state (e.g., a power saving state or L1 state) to a second power state (i.e., an active power state), according to at least one embodiment;

FIG. 5 is a flow diagram of an example method of managing transition of a communication interface from a first power state (e.g., a power saving state or L1 state) to a second power state (i.e., an active power state), according to at least one embodiment;

FIG. 6A is a block diagram of an example generative language model system suitable for use in implementing some embodiments of the present disclosure;

FIG. 6B is a block diagram of an example generative language model that includes a transformer encoder-decoder suitable for use in implementing some embodiments of the present disclosure;

FIG. 6C is a block diagram of an example generative language model that includes a decoder-only transformer architecture suitable for use in implementing some embodiments of the present disclosure;

FIG. 7 is a block diagram of an example computing device suitable for use in implementing some embodiments of the present disclosure; and

FIG. 8 is a block diagram of an example data center suitable for use in implementing some embodiments of the present disclosure.

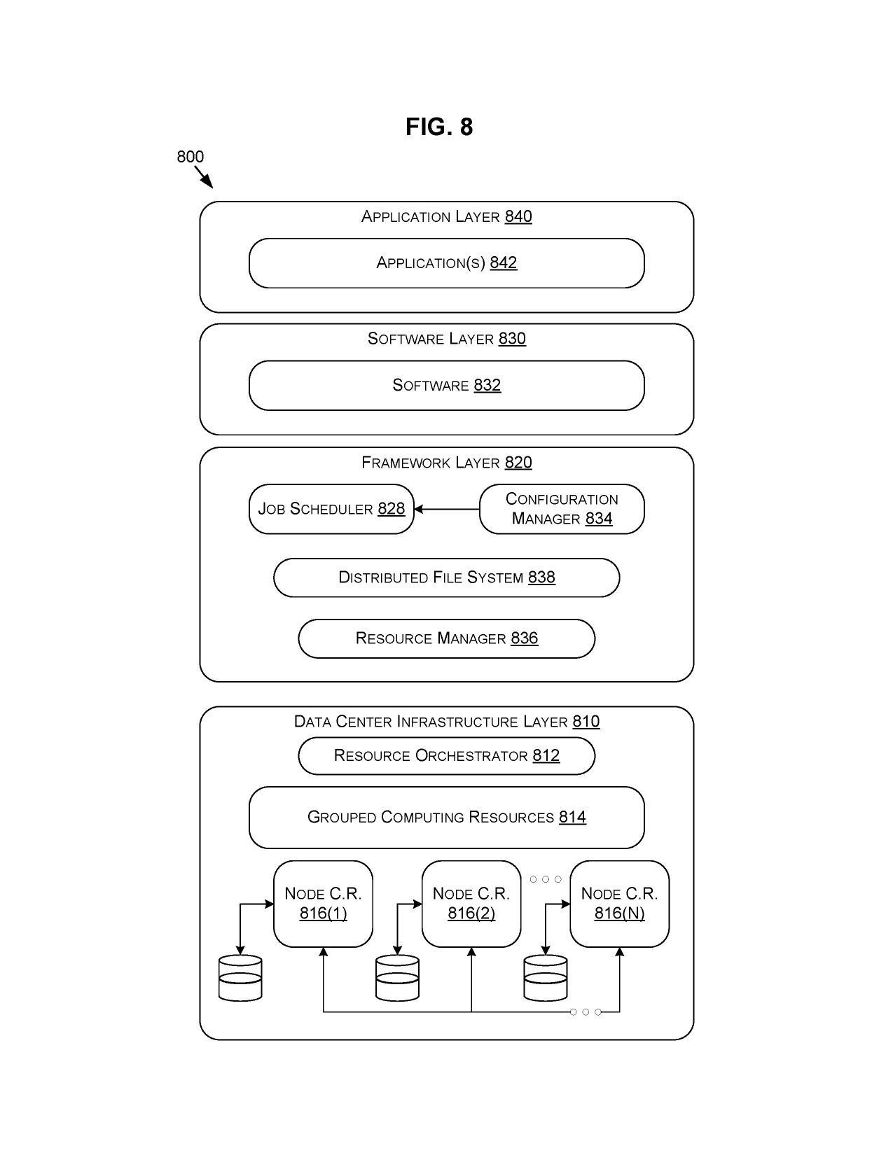

### DETAILED DESCRIPTION

Datacenters may include various computing systems capable of a large amount of computing power. Such computing power can be provided by computing systems having multiple processing units (e.g., central processing units (CPUs), graphics processing units (GPUs), etc.) that communicate with one another via high-speed communication interfaces. Accordingly, the increase in the number of high-speed communication interfaces or links that are required in such computing systems has led to a corresponding increase in the amount of power consumption by those high-speed communication interfaces.

The power consumed by the high-speed communication interfaces can represent a significant portion of a total power consumed by the processing units (e.g., CPUs, GPUs, etc.). Moreover, additional equipment associated with the use of the high-speed communication interfaces (e.g., high-speed switches) further contributes to the power consumption relating to processing unit-to-processing unit communications. One approach to reducing the amount of power consumed by a high-speed communication interface is to transition those interfaces into an energy or power saving state (herein referred to as the “L1” power state) when the interfaces are not being used to transmit communications. Dynamically entering and exiting the L1 power state causes latency due to the L1 exit operation which affects the performance of the application under consideration. Therefore, reducing the power consumption through this method requires precise timing and synchronization of the high-speed interface state transitions with the communication computing programs (e.g., communication kernels of the computing system). To address this issue, systems set L1 entry thresholds conservatively to prevent any adverse impact on performance, which causes the high-speed interface to remain in an “active” power state which consumes a large amount of power. This leads to the undesirable result where the high-speed communication interface is in the high-power consuming “active” state for longer periods of time, including instances when powering the communication interface is not required.

Aspects and embodiments of the present disclosure address these and other challenges by providing for systems and methods to generate one or more instructions or “hints” associated with efficiently transitioning a high-speed communication interface between a low power state (i.e., an L1 power state) and an active power state. According to embodiments, a first power consumption level associated with the low power state (e.g., an L1 power state) is less than a second power consumption level associated with the active power state. In some embodiments, control logic generates and provides an “early wake” instruction or hint (herein the “early wake hint instruction”) to a processing unit (e.g., CPUs, GPUs, etc.) communicatively coupled to another processing unit via a communication interface. According to embodiments, the processing unit uses the early wake hint instruction to initiate a wake operation with an associated communication interface, where the wake operation transitions the communication interface from the L1 power state to an active power state. Once transitioned to the active power state, the communication interface can be used for processing one or more communications between the processing units. Advantageously, the early wake hint instruction enables transition of the communication interface to the active power state prior to a launching of a communication kernel to communicate one or more packets from a transmitting processing unit (e.g., a transmitting GPU) and a receiving processing unit (e.g., a receiving GPU).

According to embodiments, the control logic generates and provides a “sleep” instruction or hint (herein the “sleep hint instruction”) to the processing unit to enable the transition of the communication interface from the active power state to the LI power state upon completion of the transmission of the one or more communications by the communication interface.

According to embodiments, the control logic of the computing system may manage power state transitions with respect to the execution of operations and computations associated with an artificial intelligence (AI) model (e.g., a machine learning (ML) model). According to an embodiment, the control logic generates the one or more hint instructions (e.g., the one or more wake hint instructions or sleep hint instructions) at compile time based on data stored in or otherwise associated with an AI model (e.g., a deep learning model such as a neural network graph or model, a large language model (LLM), etc.). The AI model can be represented as a structure or network topology that includes a set of layers including computational layers and related communication instances. According to an embodiment, each layer of the AI model can represent a structure or network topology in the model's architecture, which takes information from the previous layers and then passes it to the next layer. In an embodiment, the AI model may include or otherwise be associated with a neural network graph including a set of nodes corresponding to computation layers and corresponding communication instances associated with the execution of the computation layers. These communication instances are both dependent on the completion of specific previous computation and used by a subsequent computation. In an embodiment, the neural network graph maintains data associated with these dependencies between computation layers and communication instances.

In one embodiment, the control logic can analyze the data or knowledge of the neural network graph to identify dependencies between one or more computational layers to be executed by a processing unit and the corresponding communications to be transmitted via the associated communication interface. Using the identified dependencies, the control logic identifies one or more points within the neural network graph to insert a hint instruction (herein “hint insertion points”).

According to an embodiment, the control logic can be implemented in a system including a library of inter-processing unit communication types (e.g., multi-GPU collective communication primitives or “communication library”). In this embodiment, a communication type or primitive associated with a hint instruction can be inserted in the communication library when a next kernel to be launched is identified as a communication type. During runtime, the control logic can identify the hint instruction in the library and, in response, send a hint instruction to a corresponding processing unit to enable the communication interface to be transitioned from the L1 power state to the active power state.

Advantageously, the hint insertion point within the AI model (e.g., the neural network graph) indicates that a communication is to be executed in connection with an in-progress computation layer by the processing unit. In view of the hint insertion point, the control logic sends a hint instruction to the processing device to enable the communication interface to be woken up or transitioned from the L1 power state to the active state in advance of the upcoming communication. By executing the hint instruction prior to the communication, the communication interface is caused to exit the L1 power state and enter the active power state (i.e., transition from the L1 power state to the active power state) prior to the launch of the communication kernel. The transition to the active state executed in response to the hint instruction eliminates or reduces the L1 exit penalty, while realizing power consumption savings associated with maintaining the communication interface in the L1 power state until the hint instruction is identified.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, synthetic data generation and simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially with one or more language models (e.g., large language models (LLMs), small language models (SLMs), etc.), systems implemented at least partially in a data center, systems for performing conversational AI operations, systems for performing light transport simulation, systems for performing collaborative content creation for 3D assets, systems implemented at least partially using cloud computing resources, systems for generating or presenting an augmented reality content, a virtual reality content, a mixed reality content, and/or other types of systems.

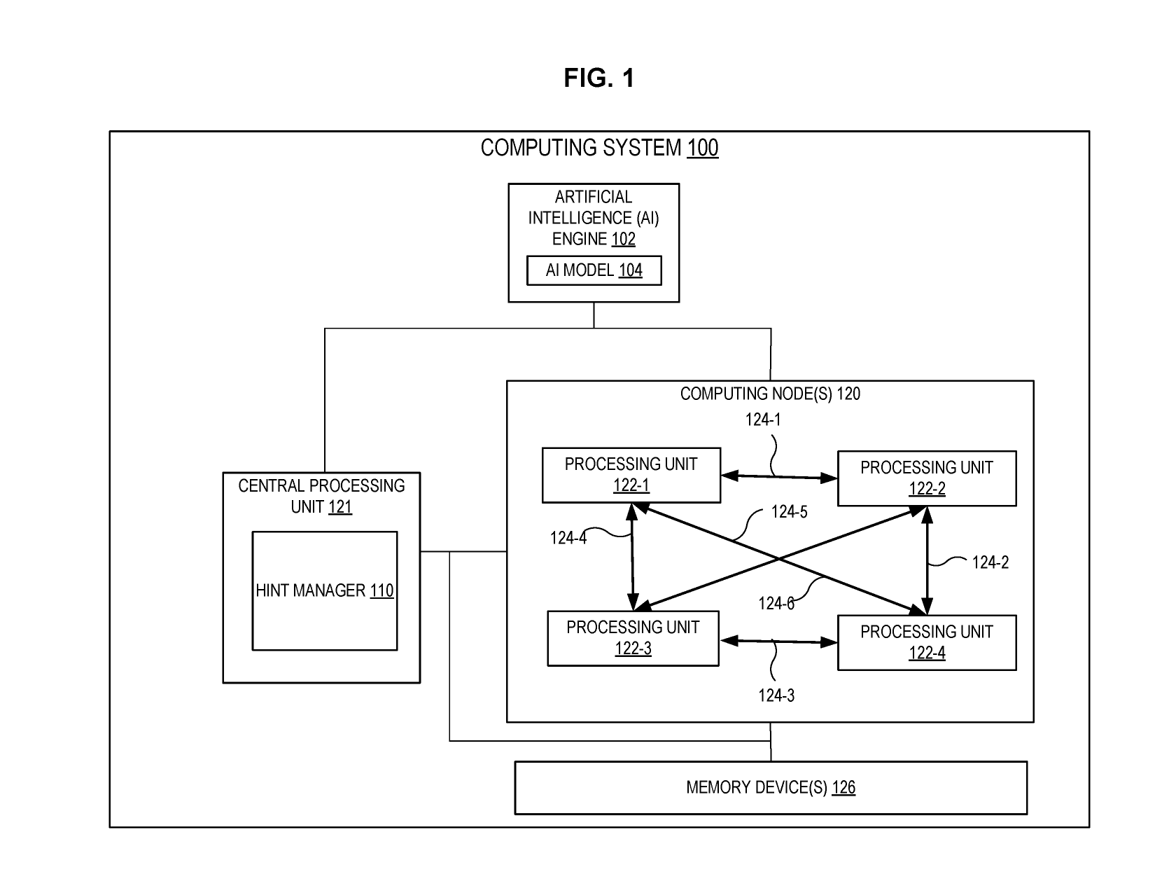

FIG. 1 is a block diagram of an example computing system 100 including control logic (herein referred to as a “hint manager 110”) executable by a central processing unit 121 to manage transitions of the power states associated with the communication interfaces 124 (e.g., communication interfaces 124-1, 124-2, 124-3, 124-4, 124-5, and 124-6) of one or more computing nodes 120 including a set of processing units 122 (e.g., processing units 122-1, 122-2, 122-3, and 122-4). According to embodiments, the computing nodes 120 may perform various computing tasks. In some embodiments, the computing tasks relate to the execution of an AI model 104 by an AI engine 102.

According to embodiments, the AI model 104 may automate tasks traditionally performed by humans. For example, AI model 104 may perform operations such as creating a representation of artificial characters, e.g., digital avatars, game characters, chatbots, and/or the like. AI model 104 may perform object recognition, automated driving, speech recognition, natural language processing, classification, segmentation, and the like. Example AI models include discriminative models and generative models. Discriminative AI models are trained to classify inputs by identifying patterns in training data (e.g., sounds, images, actions, face expressions, texts, and/or other data), such as presence of a particular type of an object within a training image or a particular word within a training speech or text or data. Generative AI models are trained to generate new data that is similar to human-created (e.g., texts) or naturally occurring (e.g., images) training data. Training can be supervised, self-supervised, unsupervised, reinforced, instructional fine-tuning, and/or the like. After successful training, deployed AI models are used to classify and/or generate new data. For example, generative language models – such as large language models (LLMs) – are capable of supporting conversations in a natural language, understanding speaker’s intent and emotions, explaining complex topics, creating new texts upon receiving suitable prompts, providing advice regarding topics of interest to a user, processing image, audio, and/or other data types, and/or performing other functions.

According to embodiments, the AI model (e.g., a deep learning model, an LLM, etc.) can include hundreds of millions or billions of learnable parameters (e.g., weights and biases of artificial neurons) and are trained using massive amounts of training data. Training of such complex models can be performed using distributed computing where multiple (e.g., tens or even hundreds of) computing nodes 120 learn from different sets of training data in parallel. Individual computing nodes deployed in distributed training can include various processing units 122, such as CPUs, GPUs, etc. According to embodiments, the computing nodes 120 may include some or all of one or more GPUs, CPUs, parallel processing units (PPUs), data processing units (DPUs), or accelerators, and/or other suitable processing devices capable of performing computing associated with the AI model 104. The processing units 122 may support any number of virtual CPUs and/or virtual GPUs. Any, some, or all computing nodes 120 may be associated with one or more memory devices, referred to herein a memory device(s) 126.

According to embodiments, the hint manager 110 monitors the activity of the computing nodes 120 of the computing system 100 to identify communication instances associated with the transmission of a communication between processing units 122 via a communication interface 124. In some embodiments, such communication instances are associated with training of an AI model 104 and/or use of a trained AI model 104. According to embodiments, to execute a communication instance on behalf of a processing unit 122, an associated communication interface 124 is transitioned from a low power state (i.e., an L1 power state) to an active power state. According to embodiments, the hint manager 110 manages the generation of one or more instructions or “hints” (herein referred to as an “early wake hint instruction” or simply an instruction) associated with transitioning the communication interface 124 between the low power state (i.e., an L1 power state) and the active power state.

According to an embodiment, the hint manager 110 can monitor (e.g., scanning or otherwise observing) communication-related activities (e.g., communication primitives included in the work dispatched to the one or more computing elements (e.g., the GPU, SMs, CEs, etc.)) and proactively generate and provide a hint or early wake hint instruction. In another embodiment, the early wake hint can be explicitly included (e.g., as a driver-inserted field) in a work stream (e.g., one or more work descriptors) associated with the work or operations processed by the one or more computing elements (e.g., the GPU, SMs, CEs, etc.) that can be interpreted by logic of the one or more computing elements to understand and process the early wake hint instruction.

According to embodiments, the hint manager 110 generates a hint corresponding to the communication instance which prompts the processing unit to initiate a wake operation associated with the associated communication interface 124. According to embodiments, the wake operation transitions the communication interface from the L1 power state to an active power state. Once transitioned to the active power state, the communication interface 124 is used for processing one or more communications associated with the identified communication instance.

According to embodiments, the hint manager 110 can generate an early wake hint instruction to be inserted into a code set executable by a processing unit 122. According to embodiments, during program execution, the processing unit 122 executes the early wake hint instruction of the code set to cause the communication interface 124 to transition from a first power state (e.g., the low power or LI power state) to a second power state (e.g., an active power state). According to embodiments, the early wake hint instruction generated by the hint manager 110 can be a user-driven hint instruction, a compiler-driven hint instruction, or a runtime hint instruction.

According to an embodiment, the hint manager 110 can generate an early wake hint instruction at compile time based on information associated with the AI model 104. In another embodiment, the hint manager 110 can generate an early wake hint instruction at runtime by analyzing the set of runtime kernels and determining when a next kernel to be launched is a communication kernel. According to embodiments, the hint manager 110 can identify various types of communication instances associated with various types of AI models 104. According to embodiments, the hint manager 110 can identify communication instances that are dependent on some specific previous computation (e.g., a related computational layer or instance) to be finished and will be needed by some subsequent computation (e.g., a dependent computational layer or instance). According to embodiments, the hint manager 110 can identify communication instance dependencies by analyzing the AI model 104 (e.g., the dependencies are captured or identified as part of the network graph specification) or through an explicit user synchronization (e.g., in the case of an optimized overlap scenario). For example, the hint manager 110 can identify data parallel weight gradient reduction communication instances of a deep learning model. In another example, the hint manager 110 can identify communication instances associated with model parallelism (e.g., tensor parallelism, expert parallelism, sequence parallelism, etc.). Such identified information may be used to determine where to insert early wake hint instructions in executable code in embodiments.

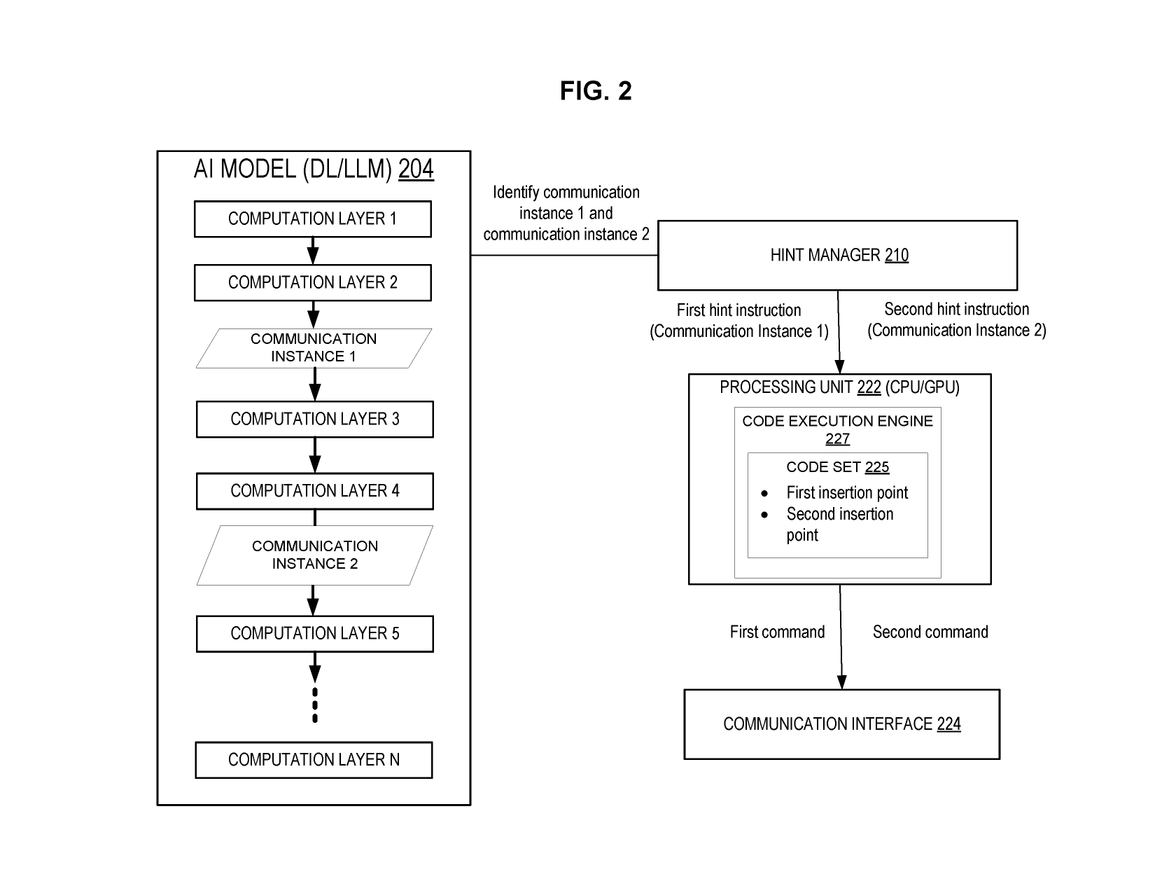

FIG. 2 illustrates an example hint manager 210 configured to identify communication instances associated with an AI model 204. As shown in the example of FIG. 2, the AI model 204 (e.g., a deep learning model, an LLM, etc.) includes a series of computation layers (e.g., computation layer 1, computation layer 2, computation layer 3…computation layer N) associated with one or more computing nodes (e.g., computing nodes 120 of FIG. 1). For example, the AI model 204 may include one or more transformer blocks (e.g., generative pre-trained (GPT) transformers). According to embodiments, each computation layer is associated with a computation operation to be executed by a processing unit (e.g., a CPU, GPU, etc.) of a computing node.

According to embodiments, the AI model 204 includes one or more communication instances to be processed via one or more communication interfaces or links of a computing node (e.g., communication interfaces 124 of FIG. 1). In an embodiment, one or more of the communication instances (e.g., communication instance 1 and communication instance 2) may have an explicit dependency upon one or more computation layers. For example, there is an identified dependency between an output of computation layer 3 and communication instance 1. Similarly, there is an identified dependency between an output of computation layer 4 and communication instance 2.

According to embodiments, at compile time and/or execution time, the hint manager 210 can analyze the AI model 204 (e.g., the knowledge of the network graph specification) and identify the dependent communication instances (e.g., communication instance 1 and communication instance 2). According to embodiments, the hint manager 210 maintains information associated with each of the identified communication instances (e.g., related dependencies, etc.).

In the example shown in FIG. 2, the hint manager 210 generates a first hint instruction associated with communication instance 1 and a second hint instruction associated with communication instance 2. According to embodiments, the hint manager 210 generates the first hint instruction and the second hint instruction at compile time based on the review of the AI model 204. Alternatively, the hint manager 210 may generate the first and second early wake hint instructions at execution time.

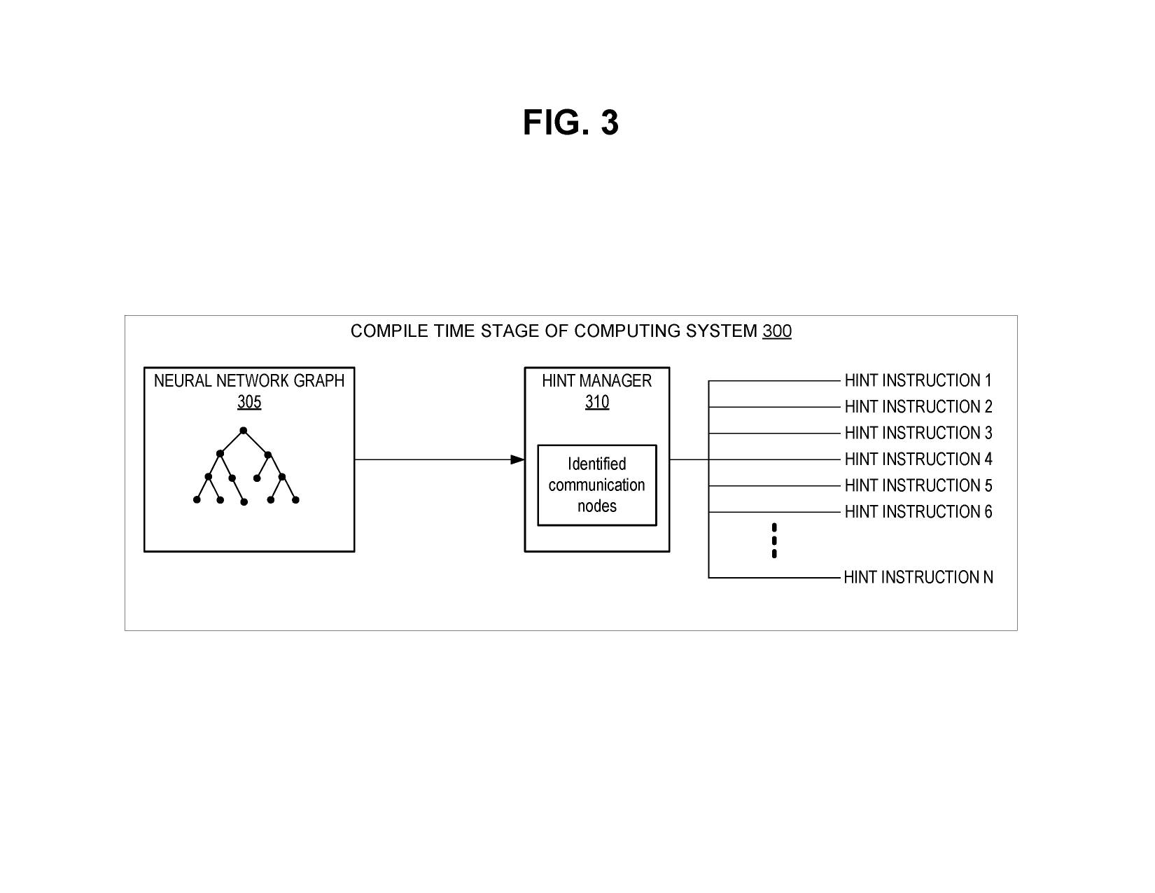

FIG. 3 illustrates an example compile time stage of a computing system 300 during which a hint manager 310 may identify one or more communication instances (e.g., communication nodes) associated with execution of an AI model including a neural network graph. In the embodiment shown in FIG. 3, an AI model can include or otherwise be associated with a neural network graph including a set of network nodes corresponding to computational nodes and communication nodes (e.g., communication instances). As shown in FIG. 3, during a compile time stage associated with a computing system 300, the hint manager 310 analyzes the knowledge (e.g., neural network nodes and relationships between the nodes) of the neural network graph 305 to identify a set of one or more communication instances. According to embodiments, the identified communication instances are dependent upon one or more computing nodes of the neural network graph 305. As illustrated, for each of the identified communication instances, the hint manager 340 generates an early wake hint instruction (e.g., hint instruction 1, hint instruction 2, hint instruction 3, … hint instruction N, where N is an integer). According to an embodiment, the hint manager 310 may generate information associated with each early wake hint instruction (e.g., hint instruction 1, hint instruction 2, … hint instruction N) which identifies a dependency between a computational node of the neural network graph 305 and a related communication instance. According to embodiments, the hint manager 310 can use the dependency information to identify a hint insertion point for each of the identified hint instructions.

Referring back to FIG. 2, in an embodiment, the hint manager 210 uses the one or more identified dependencies associated with the computational layers and communication instances (e.g., a first dependency between computational layer 2 and communication instance 1 and a second dependency between computation layer 4 and communication instance 2) and identifies one or more points associated with the execution flow of the AI model 204 (e.g., points within a network graph) to insert a hint instruction (herein referred to as one or more “hint insertion points”).

In the example shown in FIG. 2, the hint manager 210 causes the first hint instruction to be inserted in a first hint insertion point of a code set 225 executable by a processing unit 222 during execution of operations relating to the AI model 204. In the example shown in FIG. 2, the hint manager 210 causes the second hint instruction to be inserted in a second hint insertion point of the code set 225. According to embodiments, the hint manager 210 can insert the hint instructions during a pre-processing step (e.g., before the actual training or inference run associated with the AI model 204 is executed). In another embodiment, the hint manager 210 can insert the hint instructions into the code set 225 at the respective insertion points during the actual training/inference runs associated with the AI model 204 and modify the call stack during runtime execution.

Other types of applications, processing logic, etc., may also be analyzed to identify early wake hint instructions to generate and to determine insertion points for those early wake hint instructions (e.g., where to insert those early wake hint instructions into executable code). The hint manager 210 can then insert the early wake hint instructions into code sets for such other types of applications.

As shown in FIG. 2, the hint manager 210 inserts the first hint instruction at a first hint insertion point of the code set 225 executable by a code execution engine 227 (e.g., a GPU driver or runtime engine) of processing unit 222 associated with the execution of the related computation layer (e.g., computation layer 2). In the example shown in FIG. 2, the hint manager 210 inserts the second hint instruction at a second hint insertion point of the code set 225.

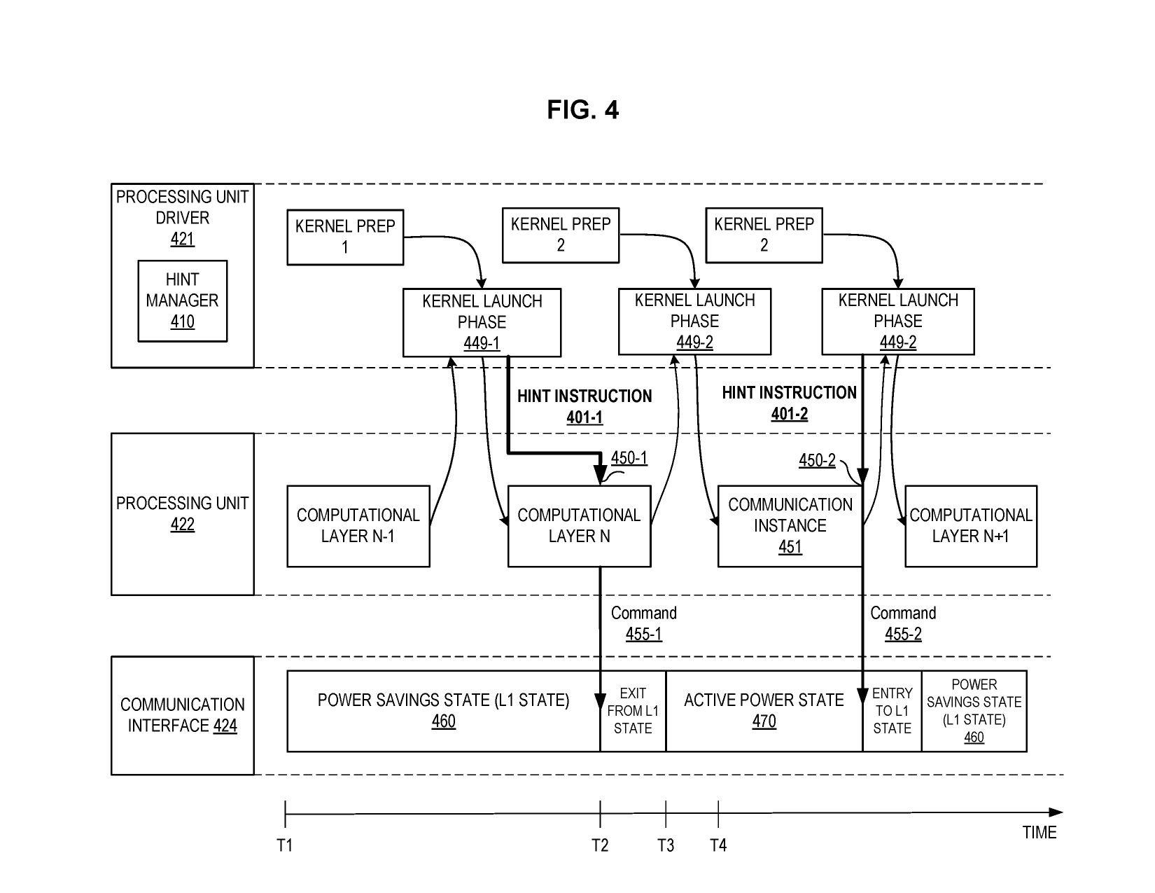

According to embodiments, the processing unit 222 executes the code set 225 and upon reaching the first hint insertion point of the code set 225, identifies the first hint instruction, and in response, generates and provides a first command to the communication interface 224. The first command causes the communication interface 224 to transition from a power saving state (L1 state) to an active power state for execution of communication instance 1. According to embodiments, upon reaching the second hint insertion point of the code set 225, the processing unit 222 identifies the second hint instruction, and in response, generates and provides a second command to the communication interface 224. The second command causes the communication interface 224 to transition from a power saving state (L1 state) to an active power state for execution of communication instance 2. Further details associated with the functionality associated with the hint manager 210 is described below with reference to FIG. 4.

FIG. 4 illustrates an example flow relating to a hint manager 410 executable by a processing unit driver 421 to generate a hint instruction relating to the transitioning of a communication interface 424 from a first power state 460 (e.g., a power saving state or L1 state) to a second power state 470 (i.e., an active power state). As shown in the example of FIG. 4, processing unit 422 performs operations associated with an AI model including the execution of computational layer N-1 and computational layer N. It should be understood that the principles and techniques described with reference to an AI model also apply to any other type of application, software and/or firmware. Accordingly, hint instructions may be generated and used to cause a communication interface 424 to wake early during execution of such other types of application, software and/or firmware.

In the example shown in FIG. 4, communication interface 424 is associated with processing unit 422 (e.g., a CPU, GPU, etc.) and is configured to transmit communications associated with processing unit 422 (e.g., a communication from processing unit 422 to another processing unit). At time T1, the communication interface 424 is in a first power state 460. In this example, the first power state is a power savings or L1 state, during which a first level of power (i.e., a low level of power) is consumed by the communication interface 424.

In an embodiment, hint manager 410 determines that communication instance 451 is associated with or dependent on the output of computational layer N. The hint manager 410 generates a hint instruction 401-1 to be provided to the processing unit 422. In an embodiment, the hint manager 410 inserts the hint instruction 401-1 at a hint insertion point 450-1 of computational layer N to cause the processing unit 422 to issue a command 455-1 to the communication interface 424. In the example shown in FIG. 4, the hint insertion point 450-1 corresponding to a point within a code set corresponding to computational layer N that is executable by processing unit 422. In an embodiment, code corresponding to the hint instruction 401-1 is inserted within the code set such that when processing unit 422 reaches the code associated with hint instruction, the processing unit 422 issues the command 455-1 (e.g., a “wake” command to cause the communication interface 424 to transition to the active power state 470 to be ready to process communication instance 451).

According to embodiments, the hint manager 410 uses the knowledge of the AI model (e.g., knowledge of a neural network graph) to generate the hint instruction 401-1 and identify a corresponding hint insertion point 450-1 that allows the processing unit 422 to wake-up the communication interface 424 for handling the communication instance 451. According to embodiments, the hint manger 410 identifies an optimized hint insertion point 450-1 to prevent exposure to exit latency associated with transitioning the power state of the communication interface 424, while minimizing the period in which the communication interface 424 is in the active power state 470 prior to execution of the communication instance 451 (e.g., minimizing the period between time T3 and time T4).

According to embodiments, the hint manager 410 identifies the hint insertion point 450-1 by identifying a launch phase 449-1 associated with a previous kernel relating to computational layer N associated with the communication instance. As shown in the example of FIG. 4, the hint manager 410 identifies kernel launch phase 449-1 and initiates the generation of the hint instruction 401-1 for insertion at the hint insertion point 450-1 of computational layer N. By using the kernel launch phase 449-1, the optimized hint insertion point 450-1 is identified to enable the transition of the communication interface 424 to the active state (e.g., starting at time T2 and completing at time T3) before the actual communication instance (e.g., the communication kernel) is launched (e.g. at time T4).

According to embodiments, the command 455-1 causes the communication interface 424 to exit the power savings state 460 to enable transition to the active power state 470. As shown, execution of the exit operation begins at time T2 and the transition period completes at time T3, at which time the communication interface 424 is transitioned to the active power state 470. In this example, the time period between time T2 and time T3 represents the exit latency associated with transitioning the power state of the communication interface 424.

Advantageously, as illustrated, the use of the hint instruction to cause an early wake-up (i.e., transition from the power savings state 460 to the active power state 470) results in the avoidance of exposure to exit latency penalty. In this regard, as shown, the communication interface 424 is in the active power state 470 (i.e., beginning at time T3) at the time the communication instance 451 is executed at time T4. Accordingly, the exit latency period (e.g., the period between time T2 and time T3) is completed and the communication interface 424 is in the active power state 470 (i.e., and ready for the communication instance 451) prior to execution of the communication instance 451.

According to embodiments, following completion of the execution of the communication instance 451, the hint manager 410 generates and provides a hint instruction 401-2 to cause entry of the communication interface 424 from the active power state 470 to the power savings state 460. According to an embodiment, when a communication kernel is complete, the “kernel launch phase” is notified of the status (i.e., completion). The notification is used to launch the next computational layer N+1, which is dependent on the previous layer’s completion. According to an embodiment, based on the hint instruction 401-2 inserted following completion of the communication instance 451, a command 455-2 (e.g., a “sleep” command) is issued by the processing unit 422 to transition of the communication interface 424 from the active power state 470 to the power savings state 460 (L1 state).

According to embodiments, the hint manager 410 may execute operations to insert the one or more hint instructions (e.g., hint instruction 410-1) during a pre-processing step before an actual training or inference run associated with a corresponding AI model.

In another embodiment, the hint manager 410 may execute operations to insert the one or more hint instructions during one or more actual training or inference runs, where the hint manager modifies a call stack during execution. In this embodiment, at the time of execution associated with the AI model, a processing unit driver (e.g., processing unit driver 421) or, alternatively, a runtime framework engine (e.g., TensorRT, TRT-LLM, Pytorch, etc.), can parse a hint instruction inserted in a previous phase.

According to the runtime embodiment, the hint manager may insert a “dummy” communication primitive, which is processed by the framework engine (i.e., similar to the manner in which the processing unit driver 421 processes the hint instructions 410). In an embodiment, a driver of a parallel computing platform and programming model for computing on processing units (e.g., GPUs) can embed a method that can be interpreted by a front-end unit (e.g., a unit responsible for scheduling work within a processing unit) of the processing unit and as the work is launched on a primary core configured to perform the processing on the processing units, or CE (Copy Engine) (i.e., a specialized engine configured to move data over communication interfaces) to start communication, in parallel, either a HW or HW+SW (on a light-weight microcontroller (e.g., RISC-V processors) in the GPU) can send a command to the communication interface to wake up. In an embodiment, if the communication interface is already in the active power state, any additional wakeup commands may be ignored.

According to an embodiment, the hint manager can be implemented in a system including a library of inter-processing unit communication types (e.g., multi-GPU collective communication primitives or “communication library”). In this embodiment, a communication type or primitive associated with a hint instruction can be inserted in the communication library when a next kernel to be launched is identified as a communication type. During runtime, the hint manager can identify the hint instruction in the library and, in response, send a hint instruction to a corresponding processing unit to enable the communication interface to be transitioned from the power savings state to the active power state.

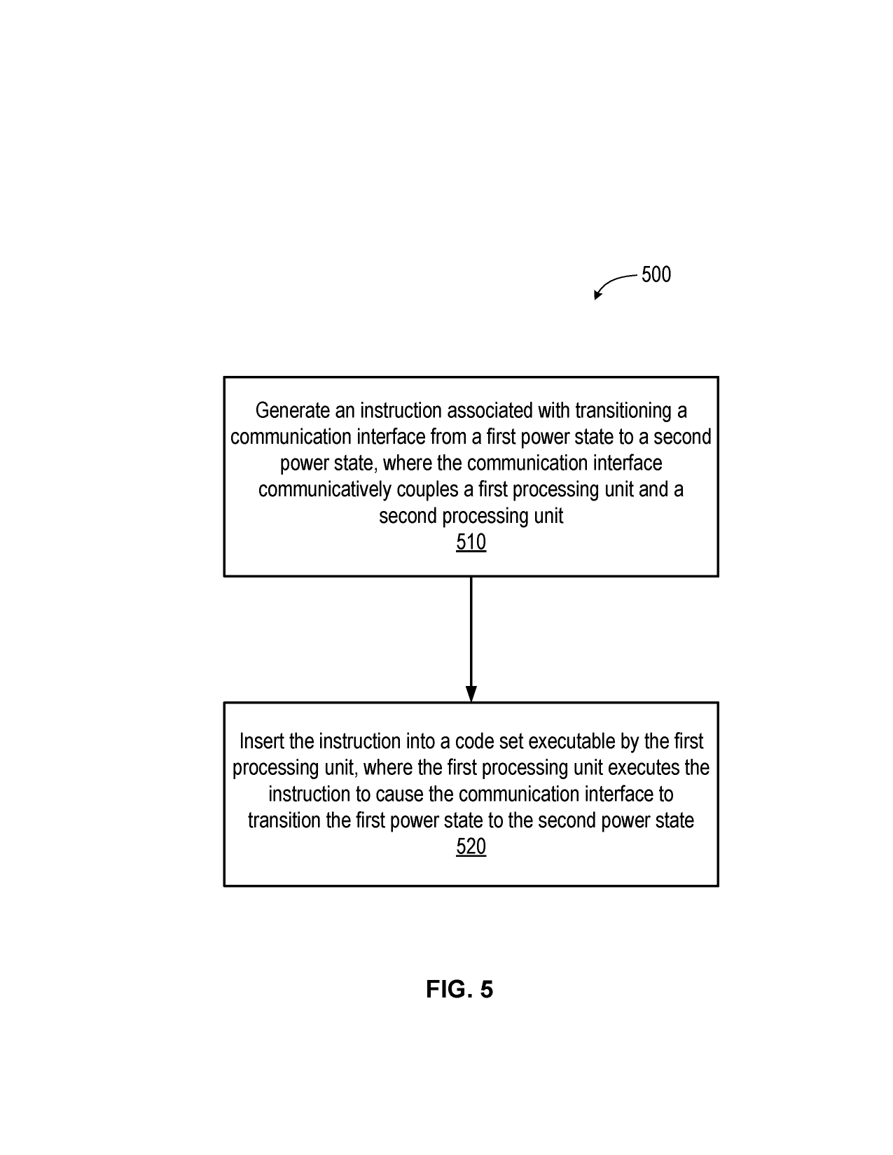

FIG. 5 is a flow diagram of an example method 500 related to generating hint instructions relating to transitioning a power state of a communication interface associated with one or more processing units (e.g., CPUs, GPUs, etc.), in accordance with at least some embodiments. Method 500 may be performed to maximize power savings associated with processing communications in a computing system, without negatively impacting the performance of the computing system. According to embodiments, the method 500 may be performed by control logic (e.g., hint manager 110, 210, 310, 410 of FIGS. 1-4, respectively). Method 500 may be performed by the control logic associated with one or more processing units (e.g., CPUs and/or GPUs), which may include (or communicate with) one or more memory devices. According to embodiments, the method 500 may be performed to manage power state transitions associated with a communication interface in a computing system associated with executing an AI model (e.g., a deep learning model, an LLM, etc.). Various operations of method 500 may be performed in a different order compared with the order shown in FIG. 5. Some operations of the methods may be performed concurrently with other operations. In at least one embodiment, one or more operations shown in FIG. 5 may not always be performed.

At block 510, control logic (e.g., hint manager 110, 210, 310, 410 of FIGS. 1-4, respectively) generates an instruction (i.e., a hint instruction) associated with transitioning a communication interface from a first power state to a second power state, where the communication interface communicatively couples a first processing unit and a second processing unit. According to embodiments, the first power state is a power saving state (or L1 state). According to embodiments, the second power state is an active power state. In an embodiment, a first power consumption level associated with the first power state is less than a second power consumption level associated with the second power state. In an embodiment, the communication interface (e.g., NVDIA® NVLink®) may be used to process a communication instance associated with a computational layer of an AI model. In an embodiment, the instruction may represent a “hint” to the first processing unit to enable issuance of a command to transition the power state of the communication instance.

At block 520, control logic inserts the instruction into a code set executable by the first processing unit, where the first processing unit executes the instruction to cause the communication interface to transition the first power state to the second power state. In an embodiment, code associated with the instruction is inserted into the code set at an insertion point selected by the control logic. In an embodiment, the insertion point is selected such that the communication interface is fully transitioned (i.e., following the latency period associated with exiting from the first power state (i.e., the power savings state)) to the second power state (i.e., the active power state). Advantageously, the communication interface is in the second power state (i.e., the active power state) in advance of execution of a communication from the first processing unit to the second processing unit.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models – such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as Open-USD, and/or other data types), systems implemented at least partially using cloud computing resources, and/or other types of systems.

In at least some embodiments, language models, such as large language models (LLMs) and/or other types of generative artificial intelligence (AI) may be implemented. These models may be capable of understanding, summarizing, translating, and/or otherwise generating text (e.g., natural language text, code, etc.), images, video, computer aided design (CAD) assets, omniverse and/or metaverse file information (e.g., in USD format), and/or the like, based on the context provided in input prompts or queries. These language models may be considered “large,” in embodiments, based on the models being trained on massive datasets and having architectures with large number of learnable network parameters (weights and biases) – such as millions or billions of parameters. The LLMs/VLMs/etc. may be implemented for summarizing textual data, analyzing and extracting insights from data (e.g., textual, image, video, etc.), and generating new text/image/video/etc. in user-specified styles, tones, and/or formats. The LLMs of the present disclosure may be used exclusively for text processing, in embodiments, whereas in other embodiments, multimodal LLMs may be implemented to accept, understand, and/or generate text along with other types of content like images, audio, and/or video. For example, vision language models (VLMs), or more generally multimodal language models, may be implemented to accept image, video, audio, textual, 3D design (e.g., CAD), and/or other inputs data types and/or to generate or output image, video, audio, textual, 3D design, and/or other output data types.

Various types of LLM/VLM/etc. architectures may be implemented in various embodiments. For example, different architectures may be implemented that use different techniques for understanding and generating outputs – such as text, audio, video, image, etc. In some embodiments, LLM architectures such as recurrent neural networks (RNNs) or long short-term memory networks (LSTMs) may be used, while in other embodiments transformer architectures – such as those that rely on self-attention mechanisms – may be used to understand and recognize relationships between words or tokens. One or more generative processing pipelines that include LLMs may also include one or more diffusion block(s) (e.g., denoisers). The language models of the present disclosure may include encoder and/or decoder block(s). For example, discriminative or encoder-only LLMs like BERT (Bidirectional Encoder Representations from Transformers) may be implemented for tasks that involve language comprehension such as classification, sentiment analysis, question answering, and named entity recognition. As another example, generative or decoder-only LLMs like GPT (Generative Pretrained Transformer) may be implemented for tasks that involve language and content generation such as text completion, story generation, and dialogue generation. LLMs that include both encoder and decoder components like T5 (Text-to-Text Transformer) may be implemented to understand and generate content, such as for translation and summarization. These examples are not intended to be limiting, and any architecture type – including but not limited to those described herein – may be implemented depending on the particular embodiment and the task(s) being performed using the model(s).

In various embodiments, the LLMs/VLMs/etc. may be trained using unsupervised learning, in which an LLM learns patterns from large amounts of unlabeled text/audio/video/image/etc. data. Due to the extensive training, in embodiments, the models may not require task-specific or domain-specific training. LLMs that have undergone extensive pre-training on vast amounts of unlabeled text data may be referred to as foundation models and may be adept at a variety of tasks like question-answering, summarization, filling in missing information, and translation. Some LLMs may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/etc. of the present disclosure may be implemented using various model alignment techniques. For example, in some embodiments, guardrails may be implemented to identify improper or undesired inputs (e.g., prompts) and/or outputs of the models. In some non-limiting embodiments, the guardrails implemented may be similar to those described in U.S. Pat. App. No. 18,304,341, filed on April 20, 2023, the contents of which are hereby incorporated by reference in their entirety. In some embodiments, one or more additional models – or layers thereof – may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/etc. of the present disclosure may be less likely to output language/text/audio/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated – e.g., recursively – for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources – such as APIs, plug-ins, and/or the like.

In some embodiments, multiple language models (e.g., LLMs/VLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents – e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc. – as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model – or version, instance, or agent – maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

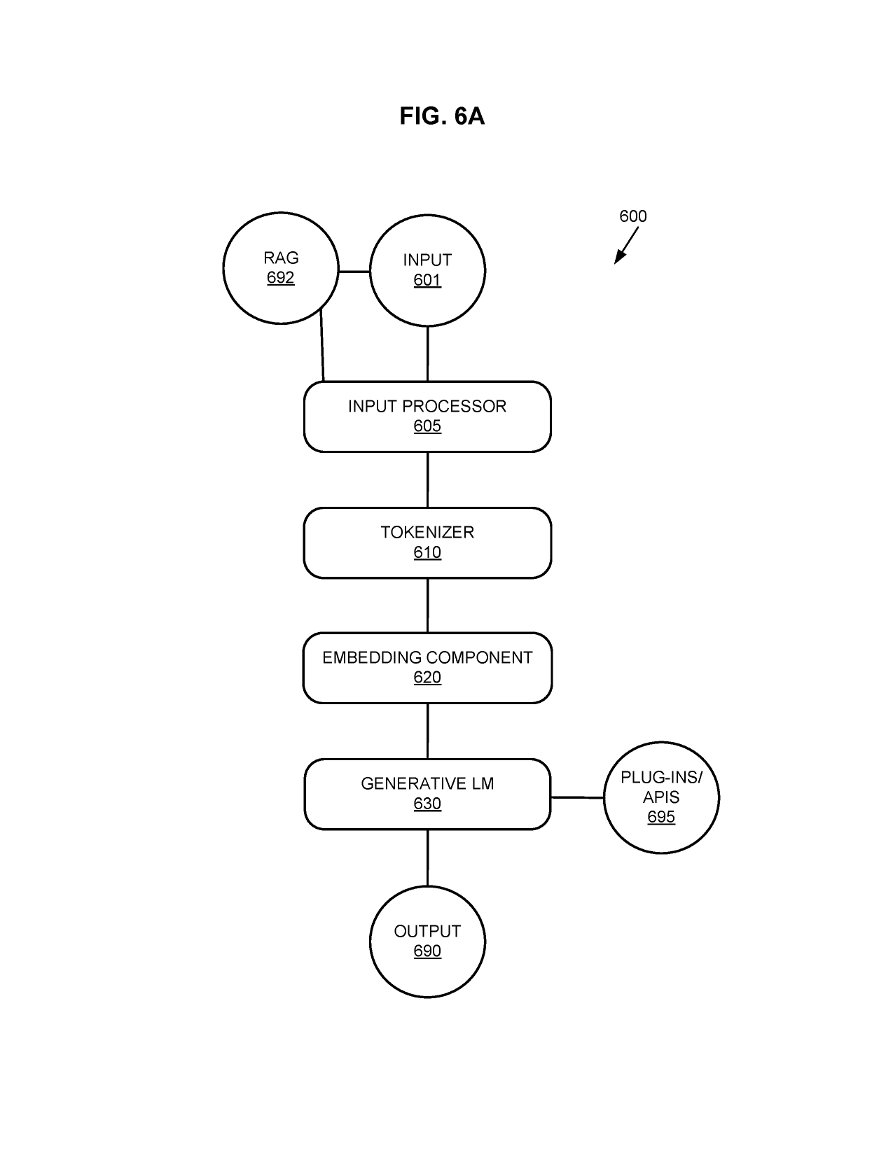

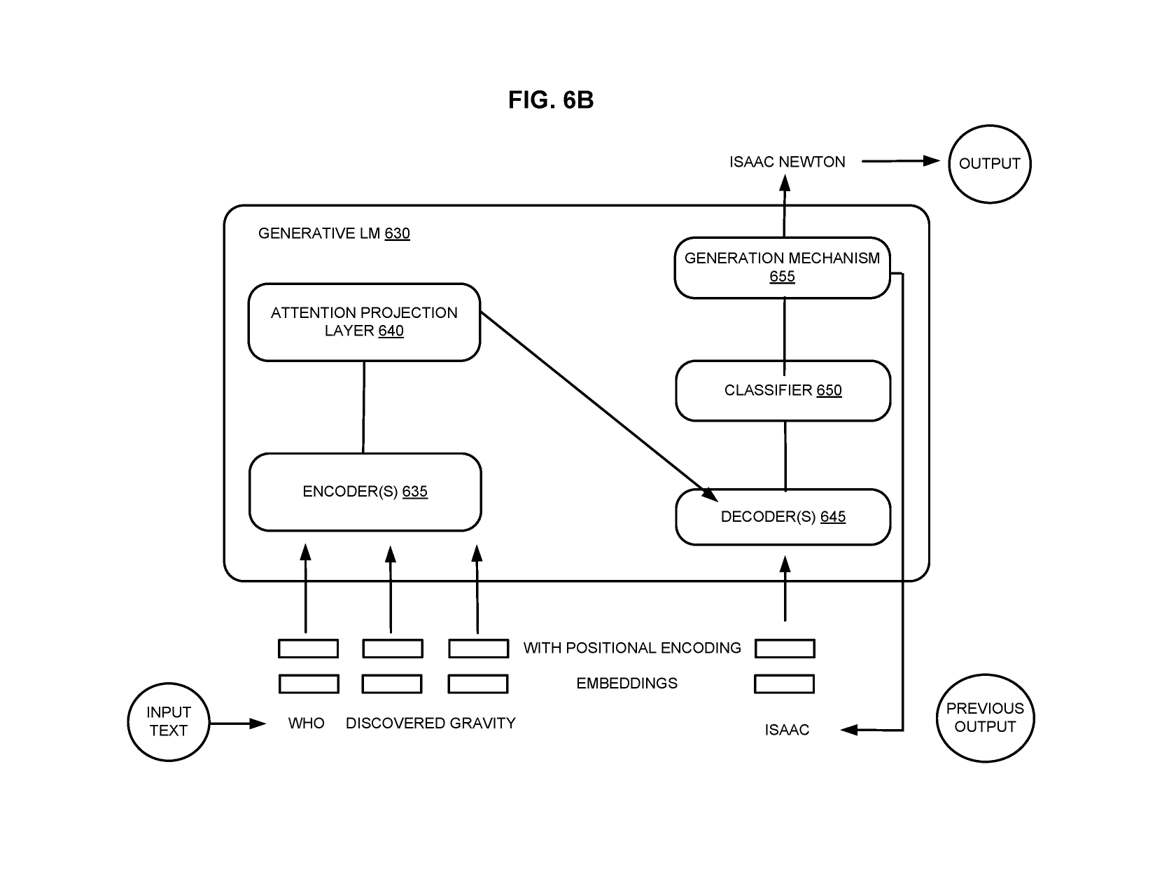

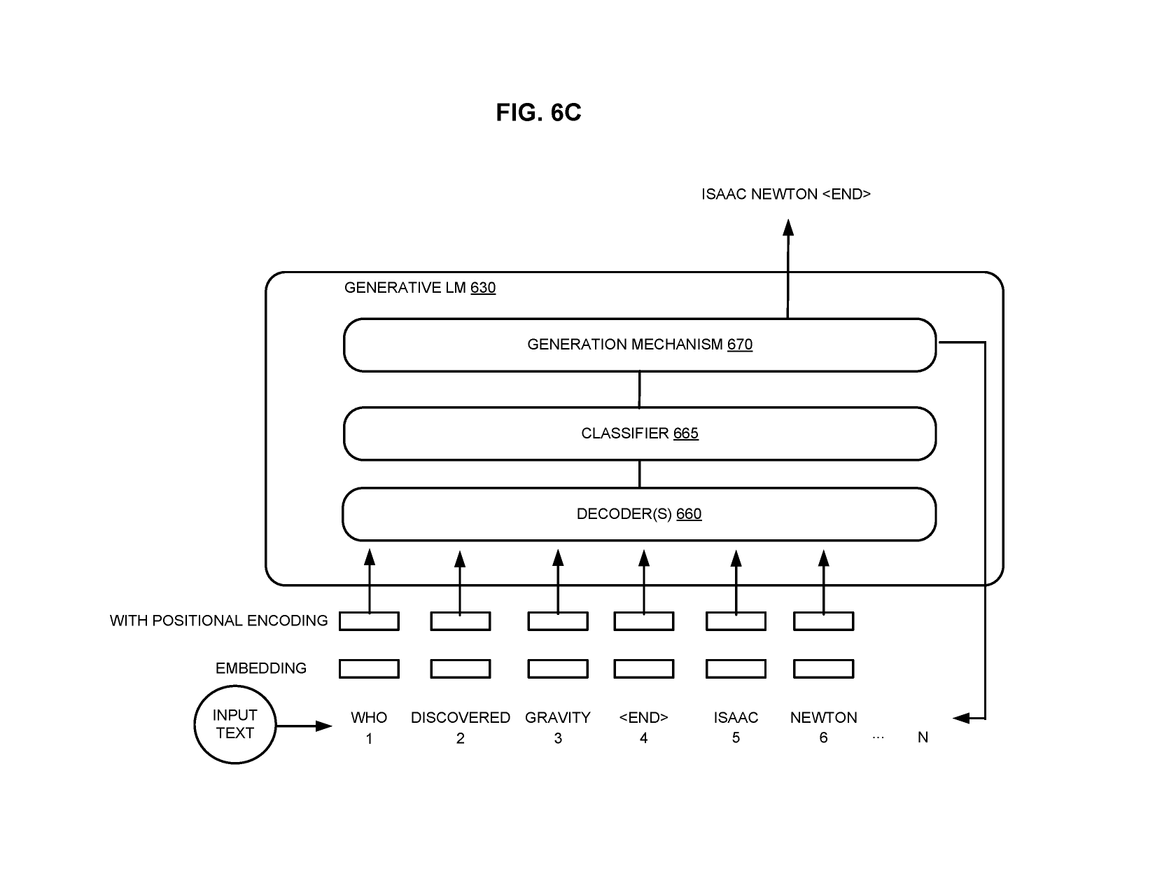

FIG. 6A is a block diagram of an example generative language model system 600 suitable for use in implementing at least some embodiments of the present disclosure. In the example illustrated in FIG. 6A, the generative language model system 600 includes a retrieval augmented generation (RAG) component 692, an input processor 605, a tokenizer 610, an embedding component 620, plug-ins/APIs 695, and a generative language model (LM) 630 (which may include an LLM, a VLM, a multi-modal LM, etc.).

At a high level, the input processor 605 may receive an input 601 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 630. In some embodiments, the input 601 includes plain text in the form of one or more sentences, paragraphs, and/or documents. Additionally or alternatively, the input 601 may include numerical sequences, precomputed embeddings (e.g., word or sentence embeddings), and/or structured data (e.g., in tabular formats, JSON, or XML). In some implementations in which the generative LM 630 is capable of processing multimodal inputs, the input 601 may combine text with image data, audio data, and/or other types of input data, such as but not limited to those described herein. Taking raw input text as an example, the input processor 605 may prepare raw input text in various ways. For example, the input processor 605 may perform various types of text filtering to remove noise (e.g., special characters, punctuation, HTML tags, stopwords) from relevant textual content. In an example involving stopwords (common words that tend to carry little semantic meaning), the input processor 605 may remove stopwords to reduce noise and focus the generative LM 630 on more meaningful content. The input processor 605 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 692 may be used to retrieve additional information to be used as part of the input 601 or prompt. For example, in some embodiments, the input 601 may be generated using the query or input to the model (e.g., a question, a request, etc.) in addition to data retrieved using the RAG component 692. In some embodiments, the input processor 605 may analyze the input 601 and communicate with the RAG component 692 (or the RAG component 692 may be part of the input processor 605, in embodiments) in order to identify relevant text and/or other data to provide to the generative LM 630 as additional context or sources of information from which to identify the response, answer, or output 690, generally. For example, where the input indicates that the user is interested in a desired tire pressure for a particular make and model of vehicle, the RAG component 692 may retrieve – using a vector search in an embedding space, for example – the tire pressure information or the text corresponding thereto from a digital (embedded) version of the user manual for that particular vehicle make and model. Similarly, where a user revisits a chatbot related to a particular product offering or service, the RAG component 692 may retrieve a prior stored conversation history – or at least a summary thereof – and include the prior conversation history along with the current ask/request as part of the input 601 to the generative LM 630.

The tokenizer 610 may segment the (e.g., processed) text into smaller units (tokens) for subsequent analysis and processing. The tokens may represent individual words, subwords, characters, etc., depending on the implementation. Word-based tokenization divides the text into individual words, treating each word as a separate token. Subword tokenization breaks down words into smaller meaningful units (e.g., prefixes, suffixes, stems), enabling the generative LM 630 to understand morphological variations and handle out-of-vocabulary words more effectively. Character-based tokenization represents each character as a separate token, enabling the generative LM 630 to process text at a fine-grained level. The choice of tokenization strategy may depend on factors such as the language being processed, the task at hand, and/or characteristics of the training dataset. As such, the tokenizer 610 may convert the (e.g., processed) text into a structured format according to tokenization schema being implemented in the particular embodiment.

The embedding component 620 may use any known embedding technique to transform discrete tokens into (e.g., dense, continuous vector) representations of semantic meaning. For example, the embedding component 620 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 601 includes image data, the input processor 601 may resize the image data to a standard size compatible with format of a corresponding input channel and/or may normalize pixel values to a common range (e.g., 0 to 1) to ensure a consistent representation, and the embedding component 620 may encode the image data using any known technique (e.g., using one or more convolutional neural networks (CNNs) to extract visual features). In some implementations in which the input 601 includes audio data, the input processor 601 may resample an audio file to a consistent sampling rate for uniform processing, and the embedding component 620 may use any known technique to extract and encode audio features – such as in the form of a spectrogram (e.g., a mel-spectrogram). In some implementations in which the input 601 includes video data, the input processor 601 may extract frames or apply resizing to extracted frames, and the embedding component 620 may extract features such as optical flow embeddings or video embeddings and/or may encode temporal information or sequences of frames. In some implementations in which the input 601 includes multimodal data, the embedding component 620 may fuse representations of the different types of data (e.g., text, image, audio) using techniques like early fusion (concatenation), late fusion (sequential processing), attention-based fusion, etc.

The generative LM 630 and/or other components of the generative LLM system 600 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 620 may apply an encoded representation of the input 601 to the generative LM 630, and the generative LM 630 may process the encoded representation of the input 601 to generate an output 690, which may include responsive text and/or other types of data.

As described herein, in some embodiments, the generative LM 630 may be configured to access or use – or capable of accessing or using – plug-ins/APIs 695 (which may include one or more plug-ins, application programming interfaces (APIs), databases, data stores, repositories, etc.). For example, for certain tasks or operations that the generative LM 630 is not ideally suited for, the model may have instructions (e.g., as a result of training, and/or based on instructions in a given prompt, such as those retrieved using the RAG component 692) to access one or more plug-ins/APIs 695 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 695 to the plug-in/API 695, the plug-in/API 695 may process the information and return an answer to the generative LM 630, and the generative LM 630 may use the response to generate the output 690. This process may be repeated – e.g., recursively – for any number of iterations and using any number of plug-ins/APIs 695 until an output 690 that addresses each ask/question/request/process/operation/etc. from the input 601 can be generated. As such, the model(s) may not only rely on its own knowledge from training on a large dataset(s) and/or from data retrieved using the RAG component 692, but also on the expertise or optimized nature of one or more external resources – such as the plug-ins/APIs 695.

FIG. 6B is a block diagram of an example implementation in which the generative LM 630 includes a transformer encoder-decoder. For example, assume input text such as “Who discovered gravity” is tokenized (e.g., by the tokenizer 610 of FIG. 6A) into tokens such as words, and each token is encoded (e.g., by the embedding component 620 of FIG. 6A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 635 of the generative LM 630.

In an example implementation, the encoder(s) 635 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 640 may convert the context vector into attention vectors (keys and values) for the decoder(s) 645.

In an example implementation, the decoder(s) 645 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 635, in an example transformer architecture, each token (e.g., word) flows through a separate path in the decoder(s) 645. During a first pass, the decoder(s) 645, a classifier 650, and a generation mechanism 655 may generate a first token, and the generation mechanism 655 may apply the generated token as an input during a second pass. The process may repeat in a loop, successively generating and adding tokens (e.g., words) to the output from the preceding pass and applying the token embeddings of the composite sequence with positional encodings as an input to the decoder(s) 645 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 635, except that it creates its queries from the layer below it and takes the keys and values (e.g., matrix) from the output of the encoder(s) 635.

As such, the decoder(s) 645 may output some decoded (e.g., vector) representation of the input being applied during a particular pass. The classifier 650 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 655 may select or sample a word or token based on a corresponding predicted probability (e.g., select the word with the highest predicted probability) and append it to the output from a previous pass, generating each word or token sequentially. The generation mechanism 655 may repeat the process, triggering successive decoder inputs and corresponding predictions until selecting or sampling a symbol or token that represents the end of the response, at which point, the generation mechanism 655 may output the generated response.

FIG. 6C is a block diagram of an example implementation in which the generative LM 630 includes a decoder-only transformer architecture. For example, the decoder(s) 660 of FIG. 6C may operate similarly as the decoder(s) 645 of FIG. 6B except each of the decoder(s) 660 of FIG. 6C omits the encoder-decoder self-attention layer (since there is no encoder in this implementation). As such, the decoder(s) 660 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 660. As with the decoder(s) 645 of FIG. 6B, each token (e.g., word) may flow through a separate path in the decoder(s) 660, and the decoder(s) 660, a classifier 665, and a generation mechanism 670 may use auto-regression to sequentially generate one token at a time until predicting a symbol or token that represents the end of the response. The classifier 665 and the generation mechanism 670 may operate similarly as the classifier 650 and the generation mechanism 655 of FIG. 6B, with the generation mechanism 670 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

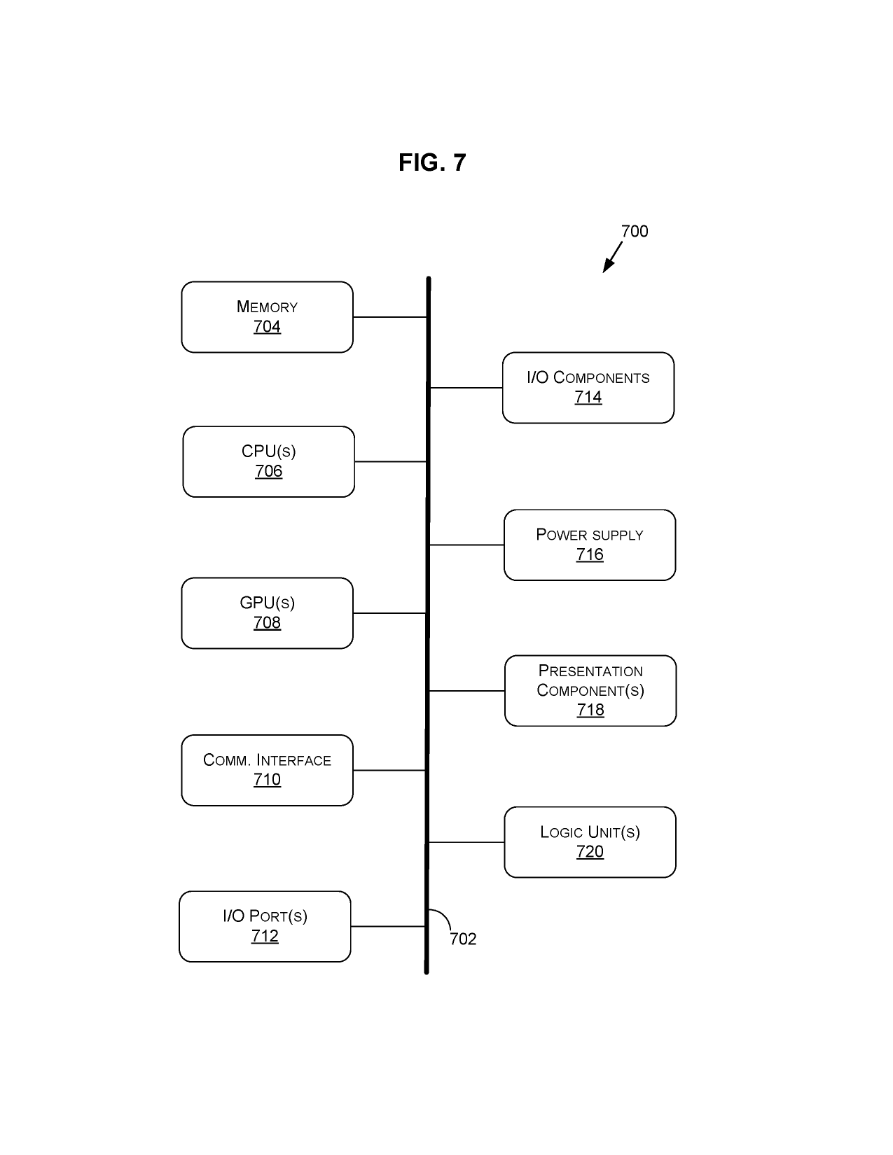

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). As such, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using a communication interface such as NVIDIA® NVLink®) or may connect the GPUs through a switch (e.g., using a communication interface switch such as NVIDIA® NVSwitch®). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs) – which may include one or more direct memory access (DMA) systems, one or more vision or vector processing units (VPUs), one or more pixel processing engines (PPEs), one or more decoupled accelerators (e.g., decoupled lookup table (DLUT) accelerators), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that allow the computing device 700 to communicate with other computing devices via an electronic communication network, included wired and/or wireless communications. The communication interface 710 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may allow the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that allow detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to allow the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-716(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may use distributed file system 738 for large-scale data processing (e.g., "big data"). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7 – e.g., each device may include similar components, features, and/or functionality of the computing device(s) 700. In addition, where backend devices (e.g., servers, NAS, etc.) are implemented, the backend devices may be included as part of a data center 700, an example of which is described in more detail herein with respect to FIG. 7.

In some embodiments, the systems and methods described herein may be performed with respect to execution of a simulation environment (e.g., NVIDIA’s DriveSIM) using simulated data (e.g., simulated sensor data of simulated sensors of a virtual or simulated machine). For example, simulated sensor data and/or map data may be used to identify regions of interest (e.g., parking spaces) and sub-regions of interest (e.g., sub-regions of a parking space that includes a curb, wheel stop, etc.) within the simulation environment, and may use this information to perform operations (e.g., parking) associated with the virtual machine within the environment. These simulated operations may be used to test performance of the underlying algorithms, systems, and/or processes prior to deploying them in the real-world. In some instances, the simulation may be used to generate synthetic training data – e.g., training data including regions of interest and/or sub-regions of interest from within the simulation. The synthetic training data (in addition to or alternatively from real-world data) may then be processed to determine geometry and/or other information related to regions of interest, such as parking spaces or pallet delivery locations within a warehouse, for example. In any example, such as where a simulation environment is used for testing, validation, training, etc., the simulation environment and/or associated training data may be rendered or otherwise generated using one or more light transport algorithms – such as ray-tracing and/or path-tracing algorithms. In some embodiments, the simulation environment and/or one or more objects, features, or components thereof may be generated or managed within a three-dimensional (3D) content collaboration platform (e.g., NVIDIA’s OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA’s PhysX SDK, in order to simulate real physics and physical interactions with simulations hosted by the platform. The platform may integrate OpenUSD along with ray tracing/path tracing/light transport simulation (e.g., NVIDIA’s RTX rendering technologies) into software tools and simulation workflows for building, training, deploying, or testing AI systems – such as systems for testing, validating, training (e.g., machine learning models, neural networks, etc.), and/or other tasks related to automotive, robot, machine, or other applications. For any of the above examples, processing logic may determine appropriate insertion points for early wake hint instructions, as discussed above, and may then insert early wake hint instructions at the determined insertion points so that a communication interface associated with one or more processors (e.g., GPUs, CPUs, DPUs, etc.) may be transitioned from a low power state to an active state without latency.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments – in which case a server may not be included in a network environment – and one or more client-server network environments – in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., "big data").

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
generating an instruction associated with transitioning a communication interface from a first power state to a second power state, wherein the communication interface communicatively couples a first processing unit and a second processing unit; and
inserting the instruction into a code set executable by the first processing unit, wherein the first processing unit executes the instruction to cause the communication interface to transition from the first power state to the second power state.

2. The method of claim 1, wherein the first power state comprises a low power state and the second power state comprises an active power state.

3. The method of claim 1, wherein the first processing unit transmits or receives a communication to or from the second processing unit via the communication interface in the second power state.

4. The method of claim 1, wherein, based on the instruction, the communication interface is transitioned from the first power state to the second power state prior to transmission of a communication between the first processing unit and the second processing unit.

5. The method of claim 1, wherein the code set is associated with a node of a neural network graph executable by the first processing unit.

6. The method of claim 5, further comprising generating an additional instruction associated with transitioning the communication interface from the second power state to the first power state.

7. The method of claim 6, further comprising inserting the additional instruction into one of an existing node or an additional node of the neural network graph, wherein the first processing unit executes the additional instruction subsequent to completion of transmission of a communication from the first processing unit to the second processing unit.

8. The method of claim 5, further comprising identifying a communication instance in a sequence of nodes of the neural network graph.

9. The method of claim 8, wherein the node comprising the instruction precedes the communication instance in the sequence of nodes of the neural network graph.

10. The method of claim 1, wherein the first processing unit comprises a graphics processing unit (GPU).

11. A system comprising:
a memory device; and
a processing device coupled to the memory device, wherein the processing device performs operations comprising:
identifying an instruction associated with transitioning a communicatively coupled communication interface from a first power state to a second power state;
causing, based on the instruction, the communication interface to transition from the first power state to the second power state; and
transmitting, via the communication interface in the second power state, a communication to a second processing device.

12. The system of claim 11, wherein a first power consumption level associated with the first power state is less than a second power consumption level associated with the second power state.

13. The system of claim 11, wherein, based on the instruction, the communication interface is transitioned from the first power state to the second power state prior to the transmission of the communication.

14. The system of claim 11, wherein the instruction is inserted into a code set corresponding to one or more nodes of a neural network graph executable by the processing device.

15. The system of claim 14, wherein the operations further comprises identifying an additional instruction associated with transitioning the communication interface from the second power state to the first power state.

16. The system of claim 15, wherein the operations further comprises inserting the additional instruction into one of an existing node or an additional node of the neural network graph, wherein the processing device executes the additional instruction subsequent to completion of the transmission of the communication from the first processing unit to the second processing unit.

17. The system of claim 11, wherein the processing device is coupled to control logic, wherein the control logic generates the instruction.

18. The system of claim 17, wherein the control logic inserts the instruction into a code set executable by the processing device.

19. The system of claim 17, wherein, during a compile time stage associated with an artificial intelligence model, the control logic identifies a set of communication instances associated with the artificial intelligence model.

20. The system of claim 19, wherein, during the compile time stage, the control logic generates an instruction corresponding to each communication instances of the set of communication instances.
